(19) United States
(12) Patent Application Publication
(10) Pub. No.: US 2026/0329732 A1
(43) Pub. Date: Oct. 22, 2026

(54) REDUCING REDUNDANCY IN TEST AUTOMATE THROUGH MACHINE LEARNING

(71) Applicant: SAP SE, Walldorf (DE)

(72) Inventors: Shanavas Madeen S, Krishnagir (IN); Ajith G, Bengaluru (IN)

(21) Appl. No.: 19/184,150

(22) Filed: Apr. 21, 2025

(51) Int. Cl. G06F 11/3668; G06F 9/54

(52) U.S. Cl. CPC G06F 11/3688; G06F 9/547

(57) ABSTRACT

Embodiments of the present disclosure include techniques for reducing redundancy in test automate using machine learning. In one embodiment, a system selects a server and a client where an application under test is hosted, verifies that a remote function call (RFC) exists for the selected server and client combination, receives a user input including an application identification (ID), and description of a test variant to automate, utilizes natural language processing to interpret the user input, utilizes a predictive model to analyze historical test data and patterns to identify an appropriate test automate variant, processes the output of the predictive model through a recommendation engine to generate a list of recommended test automate variants, selects one of the recommended test automate variant, executes the RFC to connect to the server and client and executes the selected test automate variant against the application.

### BACKGROUND

The present disclosure relates generally to computer software systems, and in particular, to systems and methods for reducing redundancy in test automate (R2TA) through machine learning.

Test automation utilizes specialized software tools to execute pre-scripted tests on an application before it is released into production. This process reduces manual effort, increases testing efficiency and enhances test coverage. When an automation test is created by a user, the user connects to the systems they intend to test via secure interconnection and communication established through various integration methods, such as application programming interfaces (APIs), and messaging protocols. Test automation often involves scripting essential actions in a specific sequence to replicate business functionalities. In an environment with diverse applications, different users may author multiple test cases for the same application leading to many test cases that test the same feature or functionality.

Therefore, existing test automation for applications suffer from the technical challenge of redundancy and inefficiency. The following disclosure provides various solutions to overcome technical problems related to test automation.

### BRIEF DESCRIPTION OF THE DRAWINGS

FIG. 1 illustrates a system for reducing redundancy in test automate through machine learning according to an embodiment.

FIG. 2 illustrates a method for reducing redundancy in test automate through machine learning according to an embodiment.

FIG. 3A illustrates an example flowchart of the system for reducing redundancy in test automate through machine learning according to an embodiment.

FIG. 3B illustrates an example system for reducing redundancy in test automation through machine learning according to an embodiment.

FIG. 4 illustrates an example application with multiple variants.

FIG. 5 illustrates hardware of a special purpose computing system configured according to the above disclosure.

### DETAILED DESCRIPTION

Described herein are techniques for reducing redundancy in test automate. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

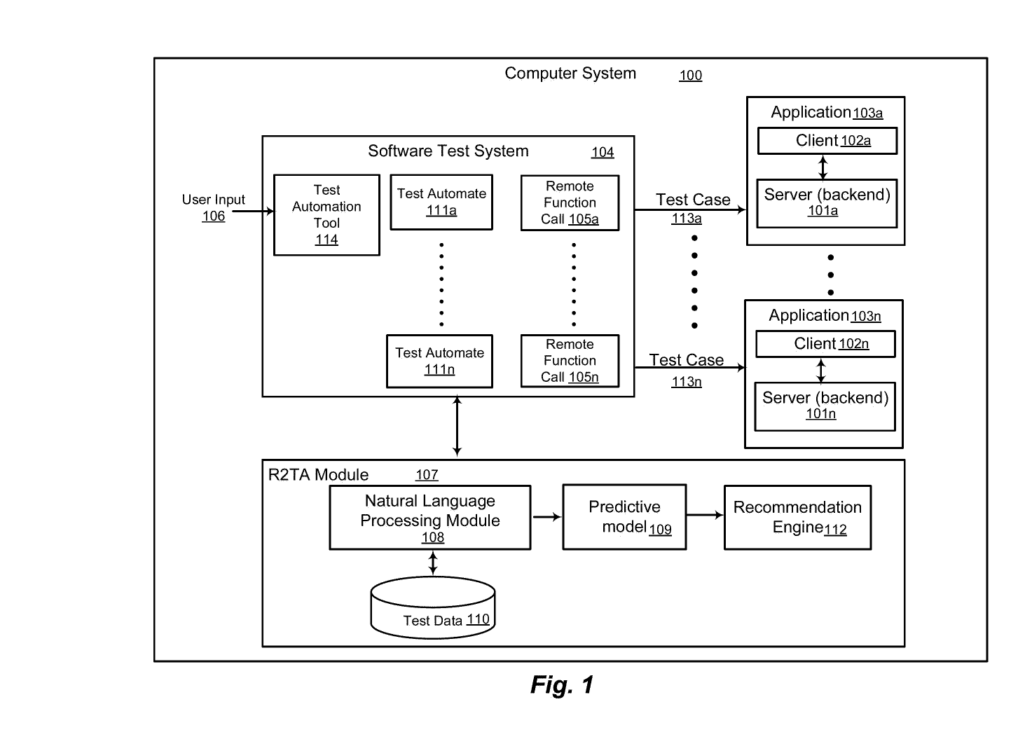

FIG. 1 illustrates a system for reducing redundancy in test automate for business application through machine learning according to an embodiment. Computer system 100 may include, for example, one or more computers comprising one or more processors and a computer readable medium (memory) for executing software to perform the techniques described herein. Here, embodiments of the present disclosure include techniques for integrating an intelligent mechanism within the test automate system to reduce redundancy of duplicate objects in the form of remote function calls (RFCs) and test cases, for example. Embodiments of the present disclosure overcome the technical challenges associated with test automate. Further examples for overcoming the technical challenges are described in more detail below.

Initially, the user selects a server 101a and a client 102a from multiple servers 101a-101n and clients 102a-102n where an application 103a under test is hosted. The reducing redundancy test automate (R2TA) module 107 checks the software test system 104 to verify that an RFC 105a exists for the selected server and client combination from multiple available RFCs 105a-105n in the software test system 104. The test automation tool 114 receives a user input 106. The user input 106 includes an application identification (ID) and description of a test variant that the user wants to automate. The test automation tool 114 then passes the user input 106 to the R2TA module 107. The reducing redundancy training automate (R2TA) module 107 utilizes a natural language processing module 108 to interpret the user input 106. R2TA module 107 utilizes a predictive model 109 to analyze historical test data 110 and patterns. The predictive model 109 identifies an appropriate test automate variant 111a among many similar tests for the same application, based on the historical test data 110 and the user input 106. In some examples, the predictive model 109 is built using tools like random forest, or gradient boosting machines. A recommendation engine 112 processes the output of the predictive model 109 and integrates the user input 106 to generate a list of recommended test automate variants from multiple test automate variants 111a - 111n available in the software test system 104. The user selects one of the recommended test automate variant 111a. The software test system 104 executes the RFC 105a to connect to the corresponding system 101a and client 102a. The software test system 104 executes the selected test automate variant 111a against the application 103a.

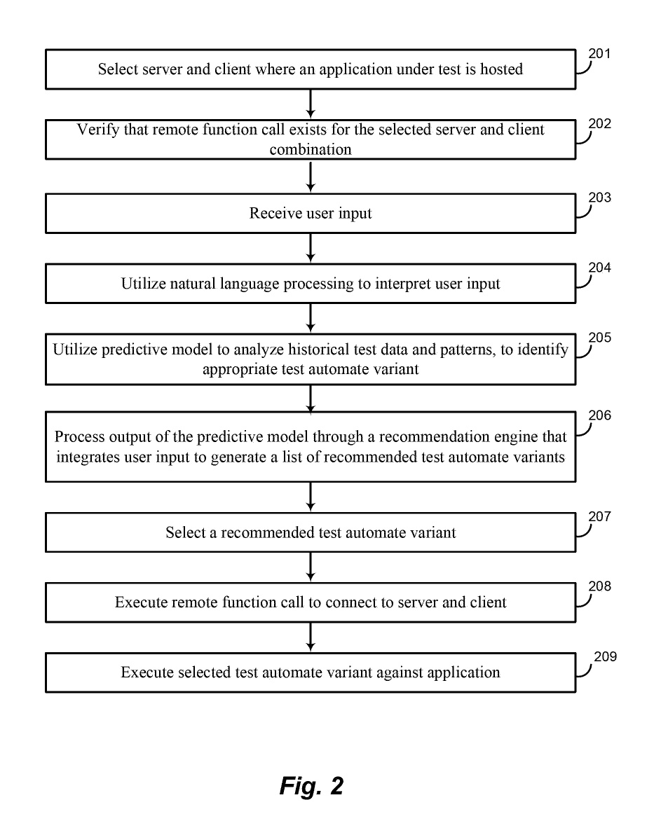

FIG. 2 illustrates a method for reducing redundancy in test automate through machine learning according to an embodiment. At 201, a user selects a server and client where an application under test is hosted. At 202, the software test system verifies that a remote function call exists for the selected server and client combination. At 203, the software test system receives a user input. At 204, the R2TA module utilizes natural language processing to interpret the user input. At 205, the R2TA module utilizes a predictive model to analyze historical test data and patterns, to identify an appropriate test automate variant. At 206, the recommendation engine processes the output of the predictive model and integrates the user input to generate a list of recommended test automate variants. At 207, the user selects a recommended test automate variant. At 208, the software test system executes a remote function call to connect to a corresponding system (e.g., server) and client. At 209 the software test system executes the selected test automate variant against the application.

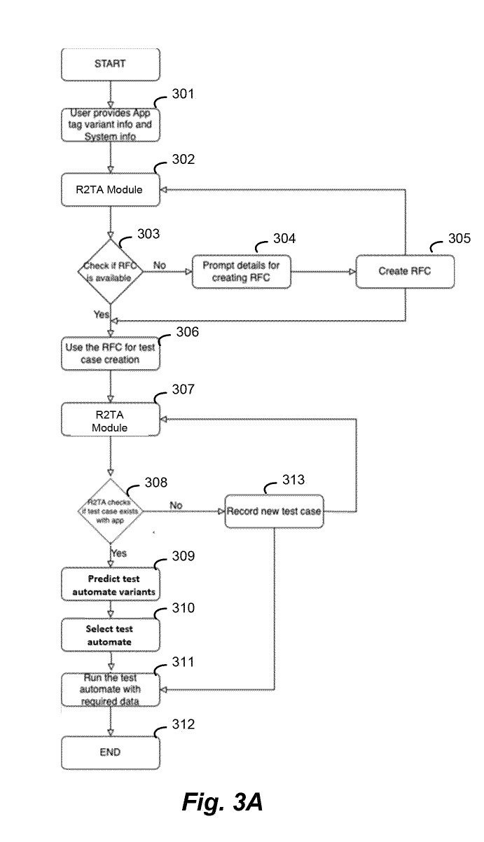

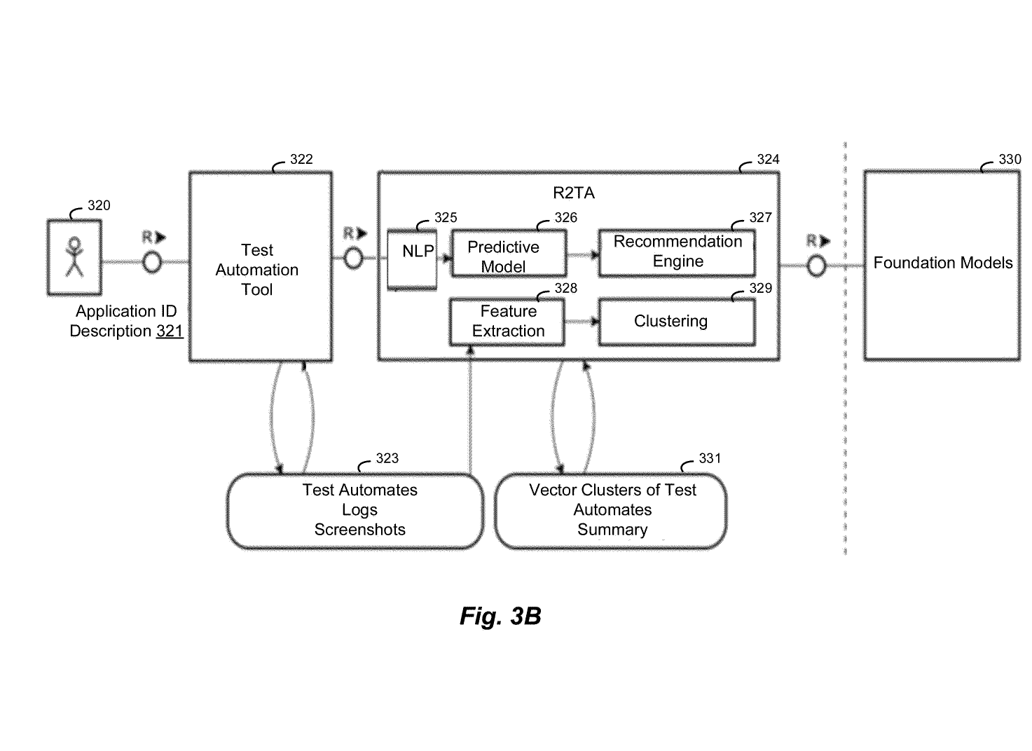

FIG. 3A illustrates an example flowchart of the system for reducing redundancy in test automate through machine learning according to an embodiment. The process begins at 301, a user describes their testing needs by providing an application identification (ID), system and client information and a description of the test variant or test scenario that the user wants to execute. For example, the user may describe a test scenario such as “initiate bank transfer in a single request.” At 302, the user input (e.g., application ID, system information, description of test variant) is provided to a R2TA module. The R2TA module interprets this input using natural language processing and predictive models to understand the context and requirements. At 303, the R2TA module checks if an RFC is available. The R2TA module can suggest to the user the required RFC based on the system and client information provided by the user to create the test case. The R2TA module processes the system and client information and checks the software test system for any existing RFCs for this system and client combination. An application programming interface (API) call is made to the software test system to obtain this information. If the response from the software test system is empty, this indicates that there are no existing RFCs or the RFC is not available. At 304, the user is prompted to enter details to create a new RFC. In some examples, the details may be host name, path prefix, username and password. At 305, a new RFC is created by the software test system for the software and client combination. This new RFC is stored as an available RFC in the software test system.

If there are any existing RFCs which match the system and client criteria, then the R2TA module responds with a list of RFC names to the user and awaits user input if the RFC provided will be used. The criteria for existing RFCs are as follows: i) the connection test for the RFC connection was successful, ii) the remote logon was successful, iii) the RFC has been utilized in a test case and the test case was completed successfully within a defined timeframe. In some examples, this defined timeframe may be the last 30 days, or any other duration specified by the user.

At 306, if an existing RFC is available, the user can choose to use the RFC for test case creation. At 307, the user selection is sent to the R2TA module. At 308, the R2TA module checks if a test case exists for the application ID and description of test variant provided by the user. The software test system contains a large collection of test cases, some with appropriate descriptions others without. These test cases are mapped to a best practice document for training a predictive model. The test cases are read, and embeddings are created for each, which are then stored along with the corresponding application ID. The embeddings for the test cases are numerical representations that capture the semantic meaning and contextual relationships of the test cases, allowing for more effective comparison and grouping of similar cases during the analysis process. A grouping or clustering algorithm is applied to cluster similar test cases together and identify their respective test automate variants. When the user enters the application ID, the predictive model can identify the test variants available for that specific application ID. To determine if a test case exists, the R2TA module leverages historical test data, feature extraction, and clustering to organize and analyze test cases, ensuring that the recommendations are relevant and efficient. The R2TA module utilizes the predictive model to extract essential features from historical test data and group the historical test data into clusters using a clustering algorithm. Clustering the test cases organizes similar test cases for effective analysis and recommendations. Some examples of essential features from the historical test data maybe “project management,” “sales order managing,” “bank transfer.” Then, the recommendation engine in the R2TA module processes the output of the predictive model to generate a tailored recommendation. At 309, the recommendation engine predicts or suggests a specific list of test automate variants based on the user’s requirements and the historical test data. The test automate variants are represented as vector clusters, enabling the recommendation engine to compare and match similar test cases efficiently. The recommendation engine utilizes vector representations of the clustered test cases to compute similarities with the output from the predictive model and the user input to generate a list of recommended test automate variants. For example, test automate variants for “bank transfer” and “payment request” may be grouped together due to their semantic similarity. The recommendation engine provides the user with a list of test automate variants for their testing needs. The recommendation engine may also provide the closest possible test automate variant of the application if the recommendation engine cannot fetch the exact test automate variant required by the user. The test automate variant can be reused, eliminating the requirement to create new automation tool objects such as RFCs and test cases. At 310, the user selects a test automate from the list of recommended test automate variants. At 311, the software test system runs the test automate with the required data. The process ends at 312.

If the test case is not available, at 313 the system allows the user to record a new test case for the application. The new test case will be used as feedback training data for the predictive model and added as an alternative test automate variant in the software test system. This alternative test automate variant will be suggested the next time this application ID is specified by a user.

FIG. 3B illustrates an example system for reducing redundancy in test automation through machine learning, according to an embodiment. The system includes a test automation tool 322, a reducing redundancy test automation (R2TA) module 324, and a foundation model 330. The R2TA module 324 includes a natural language processing module 325, a predictive model 326, a recommendation engine 327, a feature extraction module 328, and a clustering module 329. The process begins with a user 320 providing an application identification (ID) 321 and, optionally, a description of the test variant or scenario, to a test automation tool 322. For example, the user might describe the need to “initiate a bank transfer in a single request.” The test automation tool 322 captures and organizes test automates, test logs 323, providing detailed insights into each test execution, including any errors encountered during the process. Additionally, the test automation tool 322 automatically takes screenshots 323 as visual documentation of the application’s state at various moments during execution. These screenshot images can provide context for any failures or unexpected behavior, allowing the test automation tool 322 to better understand the conditions under which specific tests succeed or fail. This visual evidence complements the logs and can improve decision-making for selecting relevant test automates.

The test automation tool 322 then passes the user input 321 to the R2TA module 324. The R2TA module 324 interprets the user input 321 using natural language processing 325 and a predictive model 326 to understand context and user’s requirements. The predictive model 326, developed using machine learning techniques such as Random Forest or Gradient Boosting Machine, analyzes historical test execution data and patterns to identify trends and correlations that inform the model’s predictions. The predictive model 326 examines factors such as past test performance, application changes, and logged outcomes to intelligently recommend the most suitable test automate variant for a given scenario. This data-driven approach enhances testing efficiency by ensuring that only the most relevant and effective test variants are executed, streamlining the test automation process. For example, a predicted list of test automate for the example user input can be those related to making payments with banking transfers.

A recommendation engine 327 analyzes the output from the predictive model 326, along with additional data, to generate personalized suggestions. The recommendation engine 327 provides a suitable list of test automates based on the user’s specific requirements and historical testing data (e.g., logs, screenshots), and vector representations, ensuring that the recommendations are both relevant and effective. For example, a test variant of making bank transfer in a single test automate. A feature extraction 328 and clustering 329 module identifies and groups key features (e.g., “project management,” “sales order managing,” “bank transfer”) from the historical data of available test automates, logs, and screenshots 323 into distinct vector clusters of test automates 331 using clustering algorithms. Each vector cluster represents a grouping of similar test cases that share common characteristics. The vector clusters allows the system to compare and match similar test cases efficiently. This organization not only streamlines the analysis by allowing for quick identification of related tests but also enhances the process of generating tailored recommendations, as it enables the system to suggest the most relevant test automates based on grouped features and historical performance. For example, test automates for “bank transfer” and “payment request” might be grouped together due to their semantic similarity.

Foundation models 330 such as GPT-4.0 provide underlying intelligence for tasks such as natural language understanding, feature extraction, and summarization. The foundation models 330 enhance the system’s capability by interpreting the user’s description accurately, analyzing complex data, and generating meaningful outputs or summary of recommendations. By leveraging the sophisticated language processing abilities of GPT-4.0, the system can offer more relevant insights and recommendations, improving user interactions and the effectiveness of the test automation processes. The recommendations provide the user with actionable insights for their testing requirements. For example, the foundation models 330 may provide a recommendation such as “Recommended test automate variant/scenario: Initiate bank transfer- by creating, releasing and clearing payment request in one single action.”

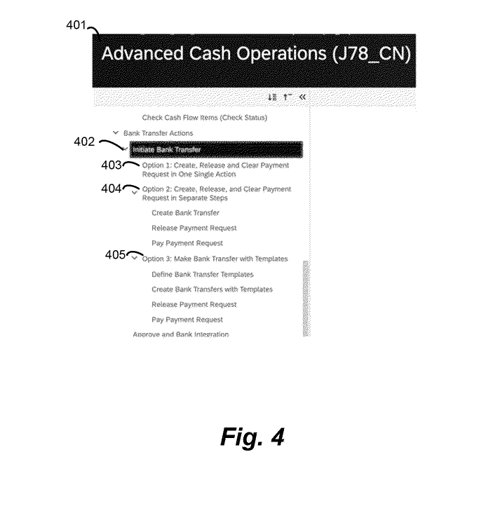

FIG. 4 illustrates an example application featuring several variants. For example, a best practice process for “advanced cash operations” 401 and the process to “initiate bank transfer” 402 as shown in FIG. 4, may be performed in three different variants, option 1 403, option 2 404 and option 3 405. Each of these options undergoes a different set of user actions for the same application. For example, Option 1 403 creates, releases, and clears payment requests in one single action. Option 2 404 creates, releases, and clears payment requests in separate steps. Option 3 405 make bank transfer with templates. Depending on the user input of the application ID with the optional parameter that describes the variant required, the system will suggest to the user all the available variants for the provided application ID.

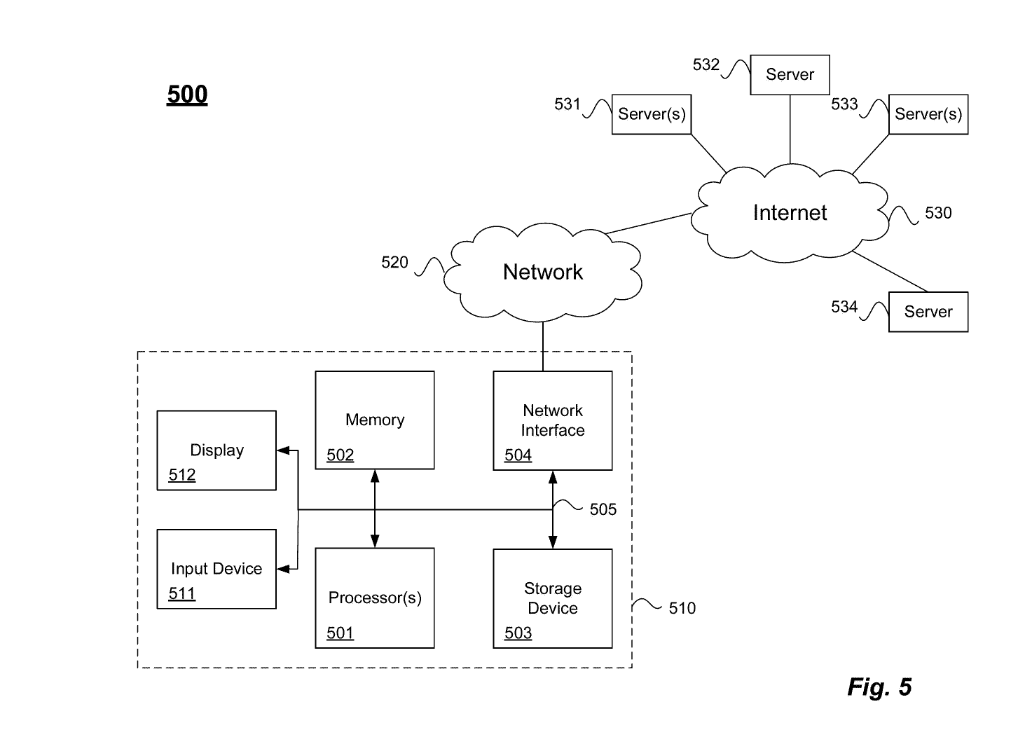

FIG. 5 illustrates hardware of a special purpose computing system 500 configured according to the above disclosure. The following hardware description is merely one example. It is to be understood that a variety of computers topologies may be used to implement the above-described techniques. An example of computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: selecting a server and a client from a plurality of servers and clients where an application under test is hosted, verifying that a first remote function call (RFC) exists for the selected server and client combination from among a plurality of remote function calls, receiving a user input, wherein the user input includes an application identification (ID), and description of a test variant to automate, utilizing a natural language processing module to interpret the user input, utilizing a predictive model to analyze historical test data and patterns, wherein the model identifies an appropriate test automate variant based on the historical test data and the user input, processing the output of the predictive model through a recommendation engine that integrates the user input to generate a list of recommended test automate variants from among a plurality of test automate variants, selecting one of the recommended test automate variant, executing the first remote function call (RFC) to connect to the selected server and client, and executing the selected test automate variant against the application.

In one embodiment, the predictive model extracts essential features from the historical test data and groups the historical test data into clusters using a clustering algorithm to organize similar test cases for effective recommendation.

In one embodiment, the recommendation engine utilizes vector representations of the clustered test cases to compute similarities with the output from the predictive model and the user input to generate a list of recommended test automate variants.

In one embodiment, the first RFC meets the criteria of: i) successful RFC connection test, ii) successful remote logon, and iii) successfully utilized in the first test case within a defined time frame.

In one embodiment, the method further comprises when the first RFC is not available, prompting a user for details to create a second remote function call (RFC).

In one embodiment, the details include host name, path prefix, username, and password.

In one embodiment, the method further comprises when the first test case is not available, recording a second test case for the application.

In one embodiment, the second test case is used as a training data for the predictive model and added as an alternative test automate variant.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
selecting a server and a client from a plurality of servers and clients where an application under test is hosted;
verifying that a first remote function call (RFC) exists for the selected server and client combination from among a plurality of remote function calls;
receiving a user input, wherein the user input includes an application identification (ID), and description of a test variant to automate;
utilizing a natural language processing module to interpret the user input;
utilizing a predictive model to analyze historical test data and patterns, wherein the model identifies an appropriate test automate variant based on the historical test data and the user input;
processing the output of the predictive model through a recommendation engine that integrates the user input to generate a list of recommended test automate variants from among a plurality of test automate variants;
selecting one of the recommended test automate variant;
executing the first RFC to connect to the selected server and client; and
executing the selected test automate variant against the application.

2. The method of claim 1, wherein the predictive model extracts essential features from the historical test data and groups the historical test data into clusters using a clustering algorithm to organize similar test cases for effective recommendation.

3. The method of claim 2, wherein the recommendation engine utilizes vector representations of the clustered test cases to compute similarities with the output from the predictive model and the user input to generate a list of recommended test automate variants.

4. The method of claim 1, wherein the first RFC meets the criteria of:
i) successful RFC connection test, ii) successful remote logon, and iii) successfully utilized in the first test case within a defined time frame.

5. The method of claim 1, further comprising when the first RFC is not available, prompting a user for details to create a second remote function call (RFC).

6. The method of claim 5, wherein the details include host name, path prefix, username, and password.

7. The method of claim 1, further comprising, when the first test case is not available, recording a second test case for the application.

8. The method of claim 7, wherein the second test case is used as a training data for the predictive model and added as an alternative test automate variant.

9. A computer system comprising:
at least one processor;
at least one non-transitory computer-readable medium storing computer-executable instructions that, when executed by the at least one processor, cause the computer system to execute a method comprising:
selecting a server and a client from a plurality of servers and clients where an application under test is hosted;
verifying that a first remote function call (RFC) exists for the selected server and client combination from among a plurality of remote function calls;
receiving a user input, wherein the user input includes an application identification (ID), and description of a test variant to automate;
utilizing a natural language processing module to interpret the user input;
utilizing a predictive model to analyze historical test data and patterns, wherein the model identifies an appropriate test automate variant based on the historical test data and the user input;
processing the output of the predictive model through a recommendation engine that integrates the user input to generate a list of recommended test automate variants from among a plurality of test automate variants;
selecting one of the recommended test automate variant;
executing the first RFC to connect to the selected server and client; and
executing the selected test automate variant against the application.

10. The computer system of claim 9, wherein the predictive model extracts essential features from the historical test data and groups the historical test data into clusters using a clustering algorithm to organize similar test cases for efficient recommendation.

11. The computer system of claim 10, wherein the recommendation engine utilizes vector representations of the clustered test cases to compute similarities with the output from the predictive model and the user input to generate a list of recommended test automate variants.

12. The computer system of claim 9, further comprising when the first RFC is not available, prompting a user for details including host name, path prefix, username, and password to create a second remote function call (RFC).

13. The computer system of claim 9, further comprising, when the first test case is not available, recording a second test case for the application.

14. The computer system of claim 13, wherein the second test case is used as training data for the predictive model and added as an alternative test automate variant.

15. A non-transitory computer-readable medium storing computer-executable instructions that, when executed by at least one processor of a computer system, cause the computer system to execute method comprising:
selecting a server and a client from a plurality of servers and clients where an application under test is hosted;
verifying that a first remote function call (RFC) exists for the selected server and client combination from among a plurality of remote function calls;
receiving a user input, wherein the user input includes an application identification (ID), and description of a test variant to automate;
utilizing a natural language processing module to interpret the user input;
utilizing a predictive model to analyze historical test data and patterns, wherein the model identifies an appropriate test automate variant based on the historical test data and the user input;
processing the output of the predictive model through a recommendation engine that integrates the user input to generate a list of recommended test automate variants from among a plurality of test automate variants;
selecting one of the recommended test automate variant;
executing the first RFC to connect to the selected server and client; and
executing the selected test automate variant against the application.

16. The non-transitory computer-readable medium of claim 15, wherein the predictive model extracts essential features from the historical test data and groups the historical test data into clusters using a clustering algorithm to organize similar test cases for efficient recommendation.

17. The non-transitory computer-readable medium of claim 16, wherein the recommendation engine utilizes vector representations of the clustered test cases to compute similarities with the output from the predictive model and the user input to generate a list of recommended test automate variants.

18. The non-transitory computer-readable medium of claim 15, further comprising when the first RFC is not available, prompting a user for details including host name, path prefix, username, and password to create a second remote function call (RFC).

19. The non-transitory computer-readable medium of claim 15, further comprising, when the first test case is not available, recording a second test case for the application.

20. The non-transitory computer-readable medium of claim 15, wherein the second test case is used as training data for the predictive model and added as an alternative test automate variant.
